(19) United States
(12) Patent Application Publication
(10) Pub. No.: US 2022/0101372 A1
(43) Pub. Date: Mar. 31, 2022

(54) METHODS, SYSTEMS, ARTICLES OF MANUFACTURE, AND APPARATUS TO ADJUST REACH

(71) Applicant: NC Ventures, LLC, Covington, KY (US)

(72) Inventors: David M. Wandel, JR., Palm Harbor, FL (US); Leslie A. Wood, Copake Falls, NY (US); Samuel Clarence Kirschner, Cincinnati, OH (US); Shobana Balasubramaniam, North Plains, OR (US)

(21) Appl. No.: 17/103,622

(22) Filed: Nov. 24, 2020

Related U.S. Application Data
(60) Provisional application No. 63/084,917, filed on Sep. 29, 2020.

(51) Int. Cl. G06Q 30/02; G06F 17/18

(52) U.S. Cl. CPC G06Q 30/0246; G06F 17/18; G06Q 30/0204; G06Q 30/0201

(57) ABSTRACT

Methods, apparatus, systems and articles of manufacture are disclosed for adjusting reach. An example apparatus includes a data accessor to obtain market data and a target reach percentage, the market data including test households and control households, an attribute controller to generate an attribute bucket, the attribute bucket including a subset of the market data, a reach determiner to determine a bucket reach percentage of the subset of the market data, and a data controller to, in response to the bucket reach percentage being less than the target reach percentage, remove a control household from the subset of the market data to generate a balanced market dataset for market analysis.

### RELATED APPLICATION

This patent arises from a continuation of Provisional U.S. Patent Application Ser. No. 63/084,917, which was filed on Sep. 29, 2020. Provisional U.S. Patent Application Ser. No. 63/084,917 is hereby incorporated herein by reference in its entirety. Priority to Provisional U.S. Patent Application Ser. No. 63/084,917 is hereby claimed.

### FIELD OF THE DISCLOSURE

This disclosure relates generally to the technical field of market research, and, more particularly, to methods, systems, articles of manufacture, and apparatus to adjust reach.

### BACKGROUND

In recent years, a substantial amount of money is invested in advertising for goods and/or services in an effort to bolster purchase and/or consumption of such goods and/or services. Regardless of a degree of quality associated with the advertised goods and/or services, if the advertising fails to reach an appropriate audience, then such advertising investment(s) are wasted.

### BRIEF DESCRIPTION OF THE DRAWINGS

FIG. 1 illustrates an example market analysis system constructed in accordance with the teachings of this disclosure to analyze market data.

FIG. 2 is a block diagram of an example reach analyzer of FIG. 1 to analyze reach of marketing campaigns.

FIG. 3 is a flowchart representative of an example method that may be executed by the example reach analyzer of FIGS. 1 and/or 2 to analyze reach of marketing campaigns.

FIG. 4 is a flowchart representative of an example method that may be executed by the example reach analyzer of FIGS. 1 and/or 2 to adjust data.

FIG. 5 is a block diagram of an example processing platform structured to execute the methods of FIGS. 3 and/or 4 and/or the example reach analyzer of FIGS. 1 and/or 2.

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

In recent years, the need for data and analytics has risen in the retail and/or manufacturing realm due to fast-paced markets and increased competition. Market data and analytics can deliver actionable insights for a company and provide better knowledge as to how that company pairs up against competitors and similar markets based on market data.

For example, marketing analysis may include determining sales lift due to advertising. That is, a company desires to know the increase in sales due to specific advertisements and/or promotions. However, to determine an accurate sales lift due to an advertisement and/or promotion, the data analyzed must have an adequate reach. As used herein, “reach” is defined as the percentage of a population that was exposed to an advertisement out of the total population. In many cases, the observed reach of an advertisement is not sufficient (e.g., low-reach data) to determine sales lift and/or other market research. For example, low-reach data may have a reach percentage of 2% (e.g., 2% of the population was exposed to the advertisement).

Thus, existing methods of analyzing market data include adjusting reach of the advertisement to a sufficient level (e.g., 10% of the population was exposed to the advertisement). For example, the market data can be adjusted in a way that does not corrupt or bias the market data. Furthermore, in cases of low-reach data, there is often relatively more confidence in the observational data that has been reached than there is in the data that has not been reached. That is, the unreached data may not be accurate (e.g., an unreached household may actually be a reached household). For example, to know that a household has been exposed to an advertisement, the household must have been identified (e.g., matched).

Existing methods of adjusting the reach of an advertisement include downsampling control data. As used herein, “control” data is the dataset of an unreached population. As used herein, “test” data is the dataset of a reached population. However, randomly downsampling control data does not balance the data. As used herein, “balanced data” is data in which the proportionate attributes of the control data in the adjusted dataset (e.g., after downsampling control data) is the same as or within a threshold of the proportionality of attributes of the test data.

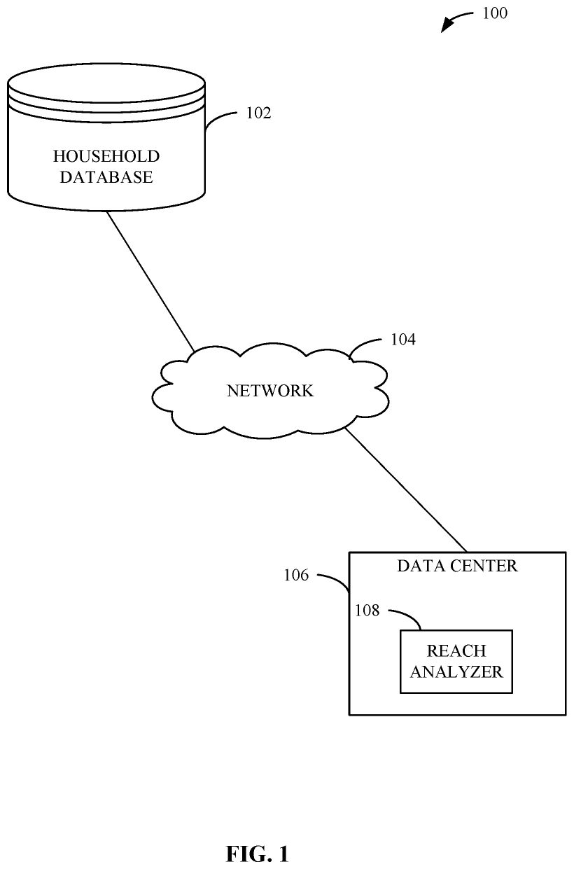

In the illustrated example of FIG. 1, an example market analysis system 100 includes an example household database 102, an example network 104, an example data center 106, and an example reach analyzer 108.

In the illustrated example of FIG. 1, the household database 102 includes household level data. In some examples, the household database 102 is associated with panelist households, non-panelist households, etc. The example household database 102 stores attribute data for each household. In some examples, the attributes include demographics, buyer behavior, loyalty, etc. The example household database 102 includes an indication of whether a household is a test household (e.g., a reached household) or a control household (e.g., an unreached household). For example, a test household includes an exposure flag to indicate exposure of the household to an advertisement.

In the illustrated example of FIG. 1, the network 104 facilitates communication between the household database 102 and/or the data center 106. In some examples, any number of household databases 102 can be communicatively coupled to the data center 106 via the network 104. The communication provided by the network 104 can be via, for example, the Internet, an Ethernet connection, USB cable, etc.

In the illustrated example of FIG. 1, the data center 106 is an execution environment used to implement the reach analyzer 108. In some examples, the data center 106 is associated with a media monitoring entity. In some examples, the data center 106 can be a physical processing center (e.g., a central facility of the media monitoring entity, etc.). Additionally or alternatively, the data center 106 can be implemented via a cloud service (e.g., AWS®, etc.).

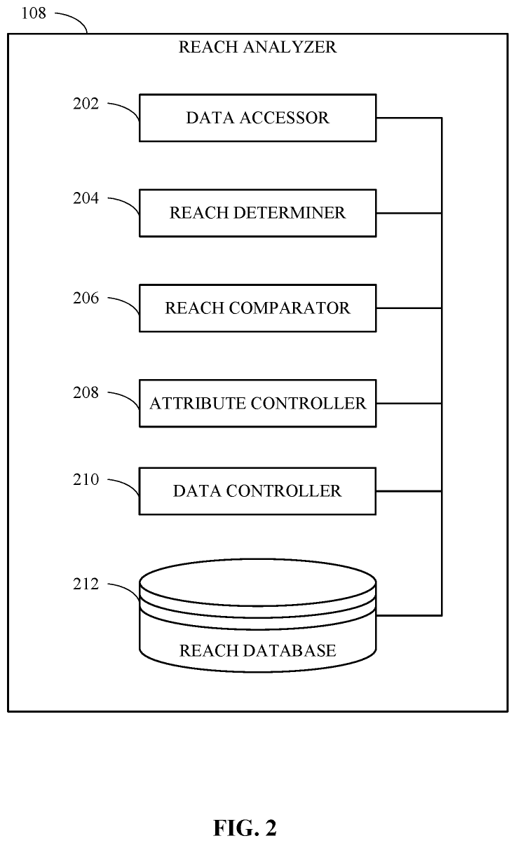

In the illustrated example, the reach analyzer 108 accesses and analyzes the data stored in the household database 102 to adjust reach of a marketing campaign (e.g., an advertisement, a promotion, etc.). In examples disclosed herein, the reach analyzer 108 compares the observed reach percentage of the data stored in the household database 102 to a target reach percentage. If the observed reach percentage is less than the target reach percentage, the reach analyzer 108 divides the data of the household database 102 into mutually exclusive, collectively exhaustive (MECE) buckets (e.g., attribute buckets). That is, the reach analyzer 108 organizes the data of the household database 102 into MECE buckets based on household attribute parameters. For example, an MECE bucket is a range, category, etc. of the household attribute parameters. For example, a first MECE bucket can be households with an annual income less than $100,000, a second MECE bucket can be households with an annual income between $100,000-$200,000, etc. The example reach analyzer 108 analyzes and adjusts the reach percentage of the data of each MECE bucket based on the target reach percentage. An example implementation of the reach analyzer 108 is described below in conjunction with FIG. 2.

In the illustrated example of FIG. 2, the reach analyzer 108 includes an example data accessor 202, an example reach determiner 204, an example reach comparator 206, an example attribute controller 208, an example data controller 210, and an example reach database 212.

In the illustrated example of FIG. 2, the data accessor 202 accesses the data stored in the household database 102. In some examples, the data accessor 202 includes means for obtaining data (sometimes referred to herein as a data obtaining means). The means for obtaining data is hardware. In some examples, the data accessor 202 accesses the household database 102 content in response to a query, on a manual basis, on a periodic basis, or on a scheduled basis. For example, the data accessor 202 may access the household database 102 once a month, once a quarter, one a year, etc. to analyze reach. In some examples, the data accessor 202 harmonizes, normalizes, and/or otherwise formats the data accessed from the household database 102. In some examples, the data accessor 202 receives user input. For example, the data accessor 202 receives a target reach percentage and/or household attribute parameters from a market analyst.

In the illustrated example of FIG. 2, the example reach determiner 204 determines the reach of a dataset. In some examples, the reach determiner 204 includes means for determining a reach percentage (sometimes referred to herein as a reach percentage determining means). The means for determining a reach percentage is hardware. For example, the reach determiner 204 determines a reach percentage of the data of the household database 102. The example reach determiner 204 determines an observed reach percentage (e.g., the percentage of test households out of the total number of households). Additionally or alternatively, the example reach determiner 204 determines a bucket reach percentage (e.g., the percentage of test households out of the total number of households for an MECE bucket). In some examples, the reach determiner 204 determines the bucket reach percentage of each MECE bucket.

In the illustrated example of FIG. 2, the example reach comparator 206 compares the calculated reach percentage(s) to a target reach percentage. In some examples, the reach comparator 206 includes means for comparing reach percentages (sometimes referred to herein as a reach percentage comparing means). The means for comparing reach percentages is hardware. That is, the example reach comparator 206 determines whether the calculated reach percentages are less than the target reach percentage. For example, the reach comparator 206 compares the observed reach percentage determined by the reach determiner 204 to the target reach percentage. Additionally or alternatively, the reach comparator 206 compares one or more of the bucket reach percentages determined by the reach determiner 204 to the target reach percentage. For example, if the observed reach percentage is 2% and the target reach percentage is 10%, the reach comparator 206 determines the observed reach percentage is less than the target reach percentage.

In some examples, the MECE buckets are associated with target bucket reach percentages. That is, the target bucket reach percentages can be different than the target reach percentage. For example, the media asset of interest may be associated with a certain demographic (e.g., a toy for kids between ages 5-10, a television show associated with women ages 20-30, etc.). Therefore, the MECE bucket associated with the demographic of interest may have a relatively higher target bucket reach percentage than the MECE buckets not associated with the demographic of interest.

In the illustrated example of FIG. 2, the example attribute controller 208 determines MECE buckets. In some examples, the attribute controller 208 includes means for generating attribute buckets (sometimes referred to herein as attribute bucket generating means). The means for generating attribute buckets is hardware. For example, the attribute controller 208 accesses the household attribute parameters received by the data accessor 202. The example attribute controller 208 determines MECE buckets based on the household attribute parameters. For example, the attribute controller 208 creates MECE buckets such that there is no overlap between the buckets (e.g., one household cannot belong to more than one bucket). The example attribute controller 208 partitions the household data (e.g., data stored in the household database 102) into the MECE buckets.

In some examples, the attribute controller 208 determines attribute importance. That is, the attribute controller 208 determines which attributes to analyze (e.g., which MECE bucket to analyze and/or adjust). For example, a market analyst may only be interested in analyzing household income data. In such examples, the attribute controller 208 determines to only adjust the buckets corresponding to a household income above and/or below a threshold.

In the illustrated example of FIG. 2, the data controller 210 adjusts control data. In some examples, the data controller 210 includes means for adjusting data (sometimes referred to herein as data adjusting means). The means for adjusting data is hardware. The example data controller 210 determines whether to remove control households. For example, if the example reach comparator 206 determines the observed reach percentage is less than the target reach percentage, the data controller 210 determines to remove control households. In examples disclosed herein, the data controller 210 determines to not remove control households if the observed reach percentage is greater than or equal to the target reach percentage. Thus, examples disclosed herein improve the efficiency of using a computing device. For example, adjusting reach of market data is associated with a computing resource cost (e.g., computing time, computing memory, etc.). Thus, if the market data and/or MECE bucket data satisfy the target reach percentage, the example data controller 210 does not adjust the reach to save resource costs (e.g., save computing time to increase computing efficiency, etc.).

The example data controller 210 determines how many control households to remove to adjust the observed reach percentage and/or the bucket reach percentage to at least the target reach percentage. If the example reach comparator 206 determines the bucket reach percentage is not less than the target reach percentage, the example data controller 210 determines the number of control households to remove is zero (e.g., the data of the MECE bucket is not adjusted). The example data controller 210 pseudo-randomly removes the determined number of control households from each MECE bucket. For example, the data controller 210 selects and flags control households to remove in a pseudo-random manner.

In examples disclosed herein, the data controller 210 reduce bias and/or other discretionary errors associated with human discretionary decision making. For example, in existing methods of adjusting reach, a market analyst may select MECE buckets and/or control households to remove to increase reach of data. However, the market analyst introduces human bias and may not select and remove control households randomly (e.g., human error). Examples disclosed herein analyze MECE buckets and pseudo-randomly identify control households to remove in response to the bucket reach percentage being less than a target reach percentage.

For example, if there are two test households and 98 control households in a MECE bucket (e.g., a total of 100 households), the reach determiner 204 determines the bucket reach percentage is 2%. If the target reach percentage is 10%, the example reach comparator 206 determines the bucket reach percentage is less than the target reach percentage (e.g., 2<10) and, thus, the example data controller 210 determines to adjust the control households of the MECE bucket. The example data controller 210 determines to remove 80 control households (e.g., 2/(100−80)=0.1, or 10%).

In the example described above, a second MECE bucket may include 12 test households and 88 control households (e.g., a total of 100 households in the second MECE bucket and 200 households in the market data). The example reach determiner 204 determines the bucket reach percentage of the second MECE bucket is 12%. If the target reach percentage of the second bucket is also 10%, the example reach comparator 206 determines the bucket reach percentage is greater than the target reach percentage (e.g., 12>10). Thus, the example data controller 210 determines to not adjust the control households of the second MECE bucket (e.g., the data controller 210 does not remove control households from the second MECE bucket).

In some examples, the data controller 210 analyzes each MECE bucket. Thus, each MECE bucket is adjusted to have at least the target reach percentage. The example data controller 210 appends (e.g., aggregates, combines, etc.) the MECE buckets together, forming an adjusted dataset with the target reach percentage that is balanced (e.g. an adjusted reach percentage). In some examples, the data controller 210 stores the adjusted dataset in the reach database 212.

While an example manner of implementing the reach analyzer 108 of FIG. 1 is illustrated in FIG. 2, one or more of the elements, processes and/or devices illustrated in FIG. 2 may be combined, divided, re-arranged, omitted, eliminated and/or implemented in any other way. Further, the example data accessor 202, the example reach determiner 204, the example reach comparator 206, the example attribute controller 208, the example data controller 210, the example reach database 212 and/or, more generally, the example reach analyzer 108 of FIG. 2 may be implemented by hardware, software, firmware and/or any combination of hardware, software and/or firmware. Thus, for example, any of the example data accessor 202, the example reach determiner 204, the example reach comparator 206, the example attribute controller 208, the example data controller 210, the example reach database 212 and/or, more generally, the example reach analyzer 108 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, data accessor 202, the example reach determiner 204, the example reach comparator 206, the example attribute controller 208, the example data controller 210, and/or the example reach database 212 is/are hereby expressly defined to include a non-transitory computer readable storage device or storage disk such as a memory, a digital versatile disk (DVD), a compact disk (CD), a Blu-ray disk, etc. including the software and/or firmware. Further still, the example reach analyzer 108 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

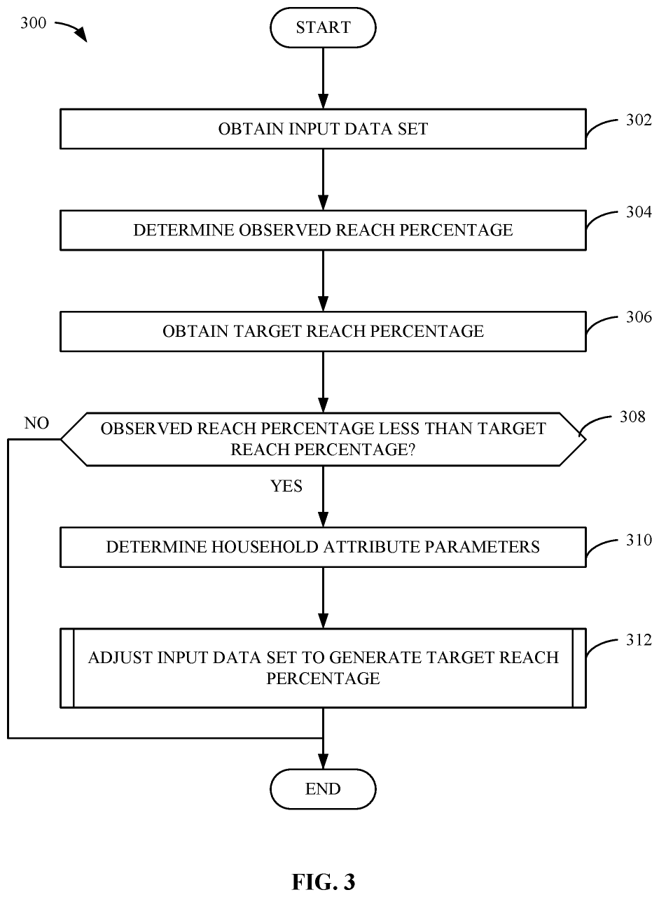

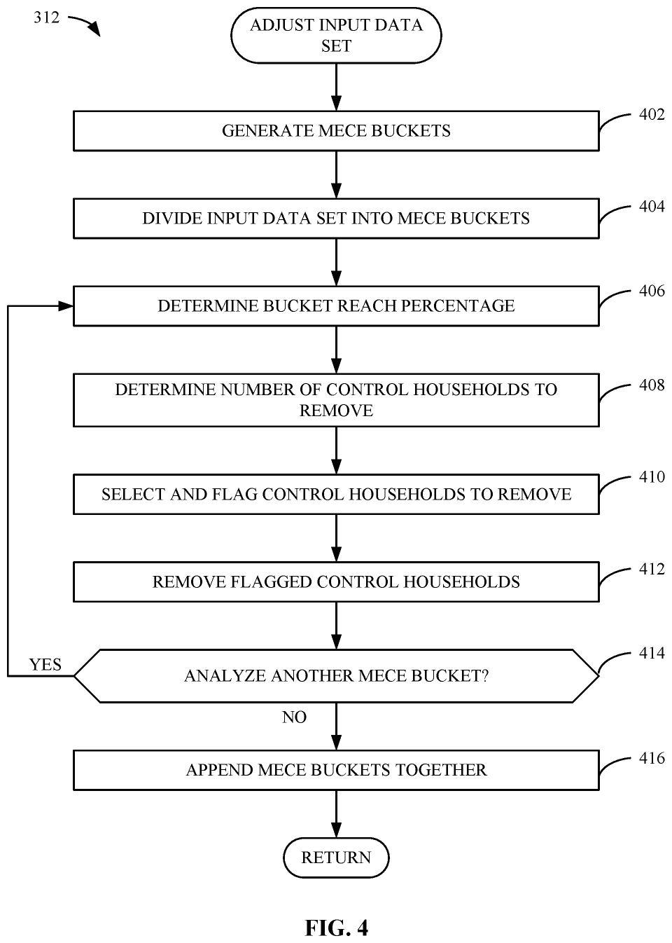

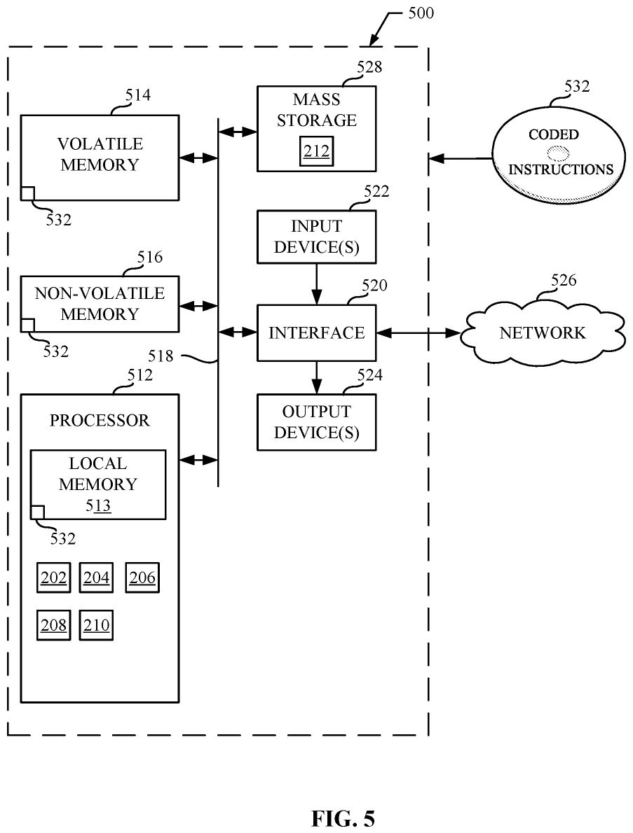

Flowcharts representative of example hardware logic, machine readable instructions, hardware implemented state machines, and/or any combination thereof for implementing the reach analyzer 108 of FIGS. 1 and/or 2 are shown in FIGS. 3-4. The machine readable instructions may be one or more executable programs or portion(s) of an executable program for execution by a computer processor and/or processor circuitry, such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowcharts illustrated in FIGS. 3-4, many other methods of implementing the example reach analyzer 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3-4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart 300 representative of example machine-readable instructions that may be executed to implement the reach analyzer 108 of FIGS. 1 and/or 2. The example machine-readable instructions of FIG. 3 begin at block 302 at which the data accessor 202 (FIG. 2) obtains an input data set. For example, the data accessor 202 accesses data stored in the household database 102 (FIG. 1). In some examples, the household database 102 includes household data including attributes (e.g., demographics, buying behavior, etc.) and an exposure flag.

The example reach determiner 204 (FIG. 2) determines an observed reach percentage (block 304). For example, the reach determiner 204 determines the percent of test households out of the total number of households in the input data set. The example data accessor 202 obtains a target reach percentage (block 306). For example, the data accessor 202 may determine a default value of a target reach percentage, receive user input indicative of a target reach percentage, etc.

The example reach comparator 206 (FIG. 2) determines if the observed reach percentage is less than the target reach percentage (block 308). For example, the reach comparator 206 compares the target reach percentage to the observed reach percentage. If, at block 308, the example reach comparator 206 determines the observed reach percentage is not less than the target reach percentage, the program 300 ends. That is, the example reach analyzer 108 determines to not adjust the reach of the data (e.g., not remove control households). If, at block 308, the example reach comparator 206 determines the observed reach percentage is less than the target reach percentage, the example attribute controller 208 (FIG. 2) determines household attribute parameters (block 310). For example, the attribute controller 208 may determine a default set of household attribute parameters to analyze, receive user input indicative of household attribute parameters to analyze, etc.

The example reach analyzer 108 adjusts the input data set to generate the target reach percentage (block 312). For example, the reach analyzer 108 determines a number of control households to remove from the input data set. Further example instructions that may be used to implement block 312 are described below in connection with FIG. 4.

FIG. 4 is a flowchart 312 representative of example machine-readable instructions that may be executed to implement the reach analyzer 108 of FIGS. 1 and/or 2. The example machine-readable instructions of FIG. 4 begin at block 402 at which the example attribute controller 208 (FIG. 2) generates MECE buckets. For example, the attribute controller 208 determines buckets having non-overlapping attributes. The example attribute controller 208 divides the input data set into the MECE buckets (block 404). For example, the attribute controller 208 analyzes the attributes of the households of the input data set and partitions the households into the MECE buckets based on the attributes.

The example reach determiner 204 (FIG. 2) determines a bucket reach percentage (block 406). For example, the reach determiner 204 identifies a first MECE bucket and determines the reach percentage of that bucket. The example data controller 210 (FIG. 2) determines a number of control households to remove (block 408). For example, the data controller 210 determines a number of control households to remove based on a comparison of the bucket reach percentage to the target reach percentage. For example, if the data controller 210 determines to not remove any control households (e.g., the bucket reach percentage is not less than the target reach percentage), the data controller 210 determines to remove zero control households from the bucket data.

The example data controller 210 selects and flags control households to remove (block 410). For example, the data controller 210 performs a pseudo-random selection process to identify and flag control households to remove. The example data controller 210 removes the flagged control households (block 412). For example, the data controller 210 removes the flagged households from the input data set.

The example attribute controller 208 determines whether to analyze another MECE bucket (block 414). For example, the attribute controller 208 determines if there are MECE buckets that haven't been analyzed. If, at block 414, the example attribute controller 208 determines to analyze another MECE bucket, control returns to block 406. If, at block 414, the example attribute controller determines to not analyze another MECE bucket, the data controller 210 appends the MECE buckets together (block 416). For example, the data controller 210 appends the MECE buckets together to form an adjusted dataset. In some examples, the data controller 210 stores the adjusted dataset in the example reach database 212 (FIG. 2). Control returns to the program 300 of FIG. 3.

FIG. 5 is a block diagram of an example processor platform 500 structured to execute the instructions of FIGS. 3-4 to implement the reach analyzer 108 of FIGS. 1 and/or 2. The processor platform 500 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a gaming console, a personal video recorder, a set top box, a headset or other wearable device, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example data accessor 202, the example reach determiner 204, the example reach comparator 206, the example attribute controller 208, and the example data controller 210.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIGS. 3-4 may be stored in the mass storage device 528, in the volatile memory 514, in the non-volatile memory 516, and/or on a removable non-transitory computer readable storage medium such as a CD or DVD.

From the foregoing, it will be appreciated that example methods, apparatus and articles of manufacture have been disclosed that adjust reach of market data. Disclosed methods, apparatus and articles of manufacture improve the efficiency of using a computing device by analyzing observed reach percentages in view of a target reach percentage to determine whether adjustments of control data are necessary to generate the target reach percentage in the market data. The disclosed methods, apparatus and articles of manufacture are accordingly directed to one or more improvement(s) in the functioning of a computer. Additionally, examples disclosed herein reduce error in the analysis process by removing discretionary inputs by a human. Accordingly, examples disclosed herein produce analysis output having less bias and/or other errors caused by human discretionary decision making.

Example methods, apparatus, systems, and articles of manufacture to adjust reach are disclosed herein. Further examples and combinations thereof include the following:

Example 1 includes an apparatus to adjust reach, the apparatus comprising a data accessor to obtain market data and a target reach percentage, the market data including test households and control households, an attribute controller to generate an attribute bucket, the attribute bucket including a subset of the market data, a reach determiner to determine a bucket reach percentage of the subset of the market data, and a data controller to, in response to the bucket reach percentage being less than the target reach percentage, remove a control household from the subset of the market data to generate a balanced market dataset for market analysis.

Example 2 includes the apparatus as defined in example 1, wherein the test households have been exposed to media and the control households have not been exposed to the media.

Example 3 includes the apparatus as defined in example 1, wherein the reach determiner is to determine an observed reach percentage of the market data.

Example 4 includes the apparatus as defined in example 3, wherein the attribute controller is to generate the attribute bucket in response to the observed reach percentage being less than the target reach percentage.

Example 5 includes the apparatus as defined in example 1, wherein the data controller is to remove a control household in a pseudo-random manner.

Example 6 includes the apparatus as defined in example 1, wherein the attribute bucket is a first attribute bucket and the subset of the market data is a first subset, and the attribute controller is to generate a second attribute bucket including a second subset of the market data.

Example 7 includes the apparatus as defined in example 6, wherein the second subset of the market data does not overlap with the first subset of the market data.

Example 8 includes the apparatus as defined in example 6, wherein the reach determiner is to determine a second bucket reach percentage of the second subset of the market data.

Example 9 includes the apparatus as defined in example 8, wherein the target reach percentage is a first target reach percentage, and further including a reach comparator to compare the second bucket reach percentage to a second target reach percentage, the second target reach percentage different than the first target reach percentage.

Example 10 includes the apparatus as defined in example 9, wherein the data controller, in response to the second bucket reach percentage being greater than the second target reach percentage, does not remove a control household from the second subset of the market data.

Example 11 includes the apparatus as defined in example 10, wherein the data controller is to combine the first subset and the second subset of the market data to generate the balanced market dataset.

Example 12 includes a non-transitory computer readable medium comprising instructions that, when executed, cause at least one processor to, at least obtain market data and a target reach percentage, the market data including test households and control households, generate an attribute bucket, the attribute bucket including a subset of the market data, determine a bucket reach percentage of the subset of the market data, and in response to the bucket reach percentage being less than the target reach percentage, remove a control household from the subset of the market data to generate a balanced market dataset for market analysis.

Example 13 includes the non-transitory computer readable medium as defined in example 12, wherein the test households have been exposed to media and the control households have not been exposed to the media.

Example 14 includes the non-transitory computer readable medium as defined in example 12, wherein the instructions, when executed, further cause the at least one processor to determine an observed reach percentage of the market data.

Example 15 includes the non-transitory computer readable medium as defined in example 14, wherein the instructions, when executed, further cause the at least one processor to generate the attribute bucket in response to the observed reach percentage being less than the target reach percentage.

Example 16 includes the non-transitory computer readable medium as defined in example 12, wherein the instructions, when executed, further cause the at least one processor to remove a control household in a pseudo-random manner.

Example 17 includes the non-transitory computer readable medium as defined in example 12, wherein the attribute bucket is a first attribute bucket and the subset of the market data is a first subset, and the instructions, when executed, further cause the at least one processor to generate a second attribute bucket including a second subset of the market data.

Example 18 includes the non-transitory computer readable medium as defined in example 17, wherein the second subset of the market data does not overlap with the first subset of the market data.

Example 19 includes the non-transitory computer readable medium as defined in example 17, wherein the instructions, when executed, further cause the at least one processor to determine a second bucket reach percentage of the second subset of the market data.

Example 20 includes the non-transitory computer readable medium as defined in example 19, wherein the target reach percentage is a first target reach percentage, and the instructions, when executed, further cause the at least one processor to compare the second bucket reach percentage to a second target reach percentage, the second target reach percentage different than the first target reach percentage.

Example 21 includes the non-transitory computer readable medium as defined in example 20, wherein the instructions, when executed, further cause the at least one processor to, in response to the second bucket reach percentage being greater than the second target reach percentage, not remove a control household from the second subset of the market data.

Example 22 includes the non-transitory computer readable medium as defined in example 21, wherein the instructions, when executed, further cause the at least one processor to combine the first subset and the second subset of the market data to generate the balanced market dataset.

Example 23 includes a method, comprising obtaining market data and a target reach percentage, the market data including test households and control households, generating an attribute bucket, the attribute bucket including a subset of the market data, determining a bucket reach percentage of the subset of the market data, and in response to the bucket reach percentage being less than the target reach percentage, removing a control household from the subset of the market data to generate a balanced market dataset for market analysis.

Example 24 includes the method as defined in example 23, wherein the test households have been exposed to media and the control households have not been exposed to the media.

Example 25 includes the method as defined in example 23, further including determining an observed reach percentage of the market data.

Example 26 includes the method as defined in example 25, further including generating the attribute bucket in response to the observed reach percentage being less than the target reach percentage.

Example 27 includes the method as defined in example 23, further including removing a control household in a pseudo-random manner.

Example 28 includes the method as defined in example 23, wherein the attribute bucket is a first attribute bucket and the subset of the market data is a first subset, and further including generating a second attribute bucket including a second subset of the market data.

Example 29 includes the method as defined in example 28, wherein the second subset of the market data does not overlap with the first subset of the market data.

Example 30 includes the method as defined in example 28, further including determining a second bucket reach percentage of the second subset of the market data.

Example 31 includes the method as defined in example 30, wherein the target reach percentage is a first target reach percentage, and further including comparing the second bucket reach percentage to a second target reach percentage, the second target reach percentage different than the first target reach percentage.

Example 32 includes the method as defined in example 31, further including, in response to the second bucket reach percentage being greater than the second target reach percentage, not removing a control household from the second subset of the market data.

Example 33 includes the method as defined in example 32, further including combining the first subset and the second subset of the market data to generate the balanced market dataset.

Example 34 includes an apparatus, comprising means for obtaining market data and a target reach percentage, the market data including test households and control households, means for generating an attribute bucket, the attribute bucket including a subset of the market data, means for determining a bucket reach percentage of the subset of the market data, and means for adjusting data to, in response to the bucket reach percentage being less than the target reach percentage, remove a control household from the subset of the market data to generate a balanced market dataset for market analysis.

Example 35 includes the apparatus as defined in example 34, wherein the test households have been exposed to media and the control households have not been exposed to the media.

Example 36 includes the apparatus as defined in example 34, wherein the reach percentage determining means is to determine an observed reach percentage of the market data.

Example 37 includes the apparatus as defined in example 36, wherein the attribute bucket generating means is to generate the attribute bucket in response to the observed reach percentage being less than the target reach percentage.

Example 38 includes the apparatus as defined in example 34, wherein the data adjusting means is to remove a control household in a pseudo-random manner.

Example 39 includes the apparatus as defined in example 34, wherein the attribute bucket is a first attribute bucket and the subset of the market data is a first subset, and the attribute bucket generating means is to generate a second attribute bucket including a second subset of the market data.

Example 40 includes the apparatus as defined in example 39, wherein the second subset of the market data does not overlap with the first subset of the market data.

Example 41 includes the apparatus as defined in example 39, wherein the reach percentage determining means is to determine a second bucket reach percentage of the second subset of the market data.

Example 42 includes the apparatus as defined in example 41, wherein the target reach percentage is a first target reach percentage, and further including means for comparing reach percentages to compare the second bucket reach percentage to a second target reach percentage, the second target reach percentage different than the first target reach percentage.

Example 43 includes the apparatus as defined in example 42, wherein the data adjusting means, in response to the second bucket reach percentage being greater than the second target reach percentage, is to not remove a control household from the second subset of the market data.

Example 44 includes the apparatus as defined in example 43, wherein the data adjusting means is to combine the first subset and the second subset of the market data to generate the balanced market dataset.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus to adjust reach, the apparatus comprising:
a data accessor to obtain market data and a target reach percentage, the market data including test households and control households;
an attribute controller to generate a first attribute bucket, the first attribute bucket including a first subset of the market data;
a reach determiner to determine a first bucket reach percentage of the first subset of the market data; and
a data controller to:
in response to the first bucket reach percentage being less than the target reach percentage, determine a number of control households to remove from the first subset of the market data based on a size of the first subset of the market data and a difference between the first bucket reach percentage and the target reach percentage;
pseudo-randomly select a corresponding number of the control households to be removed from the first subset of the market data based on the determined number of control households to be removed;
remove the selected control households from the first subset of the market data to generate a first adjusted subset of the market data; and
aggregate the first adjusted subset of the market data with a second adjusted subset of the market data to form balanced market data for market analysis, the second adjusted subset associated with a second attribute bucket, the second attribute bucket including a second subset of the market data.

2. The apparatus as defined in claim 1, wherein the test households have been exposed to media and the control households have not been exposed to the media.

3. The apparatus as defined in claim 1, wherein the reach determiner is to determine an observed reach percentage of the market data.

4. The apparatus as defined in claim 3, wherein the attribute controller is to generate the first attribute bucket in response to the observed reach percentage being less than the target reach percentage.

5. (canceled)

6. The apparatus as defined in claim 1, wherein the attribute controller is to generate the second attribute bucket including the second subset of the market data based on a household attribute different than a household attribute associated with the first subset of the market data.

7. (canceled)

8. The apparatus as defined in claim 6, wherein the reach determiner is to determine a second bucket reach percentage of the second subset of the market data.

9. The apparatus as defined in claim 8, wherein the target reach percentage is a first target reach percentage, and further including a reach comparator to compare the second bucket reach percentage to a second target reach percentage, the second target reach percentage different than the first target reach percentage.

10. The apparatus as defined in claim 9, wherein the data controller, in response to the second bucket reach percentage being greater than the second target reach percentage, does not remove a control household from the second subset of the market data, the second adjusted subset of the market data the same as the second subset of the market data.

11. (canceled)

12. A non-transitory computer readable medium comprising instructions that, when executed, cause at least one processor to, at least:
obtain market data and a target reach percentage, the market data including test households and control households;
generate a first attribute bucket, the first attribute bucket including a first subset of the market data;
determine a first bucket reach percentage of the first subset of the market data;
in response to the first bucket reach percentage being less than the target reach percentage, determine a number of control households to remove from the first subset of the market data based on a size of the first subset of the market data and a difference between the first bucket reach percentage and the target reach percentage;
pseudo-randomly select a corresponding number of the control households to be removed from the first subset of the market data based on the determined number of control households to be removed;
remove the selected control households from the first subset of the market data to generate a first adjusted subset of the market data; and
aggregate the first adjusted subset of the market data with a second adjusted subset of the market data to form balanced market data for market analysis, the second adjusted subset associated with a second attribute bucket, the second attribute bucket including a second subset of the market data.

13. (canceled)

14. The non-transitory computer readable medium as defined in claim 12, wherein the instructions, when executed, further cause the at least one processor to determine an observed reach percentage of the market data.

15. The non-transitory computer readable medium as defined in claim 14, wherein the instructions, when executed, further cause the at least one processor to generate the first attribute bucket in response to the observed reach percentage being less than the target reach percentage.

16. (canceled)

17. The non-transitory computer readable medium as defined in claim 12, wherein the instructions, when executed, further cause the at least one processor to generate the second attribute bucket including [[a]] the second subset of the market data based on a household attribute different than a household attribute associated with the first subset of the market data.

18. (canceled)

19. The non-transitory computer readable medium as defined in claim 17, wherein the instructions, when executed, further cause the at least one processor to determine a second bucket reach percentage of the second subset of the market data.

20. The non-transitory computer readable medium as defined in claim 19, wherein the target reach percentage is a first target reach percentage, and the instructions, when executed, further cause the at least one processor to compare the second bucket reach percentage to a second target reach percentage, the second target reach percentage different than the first target reach percentage.

21.-33. (canceled)

34. An apparatus, comprising:
means for obtaining market data and a target reach percentage, the market data including test households and control households;
means for generating first attribute bucket, the first attribute bucket including a first subset of the market data;
means for determining a first bucket reach percentage of the first subset of the market data; and
means for adjusting data to:
in response to the first bucket reach percentage being less than the target reach percentage, determine a number of control households to remove from the first subset of the market data based on a size of the first subset of the market data and a difference between the first bucket reach percentage and the target reach percentage;
pseudo-randomly select a corresponding number of the control households to be removed from the first subset of the market data based on the determined number of control households to be removed;
remove the selected control households from the first subset of the market data to generate a first adjusted subset of the market data; and
aggregate the first adjusted subset of the market data with a second adjusted subset of the market data to form balanced market data for market analysis, the second adjusted subset associated with a second attribute bucket, the second attribute bucket including a second subset of the market data.

35. (canceled)

36. The apparatus as defined in claim 34, wherein the reach percentage determining means is to determine an observed reach percentage of the market data.

37. The apparatus as defined in claim 36, wherein the attribute bucket generating means is to generate the first attribute bucket in response to the observed reach percentage being less than the target reach percentage.

38. (canceled)

39. The apparatus as defined in claim 34, wherein the attribute bucket generating means is to generate the second attribute bucket including the second subset of the market data.

40. (canceled)

41. The apparatus as defined in claim 39, wherein the reach percentage determining means is to determine a second bucket reach percentage of the second subset of the market data.

42. The apparatus as defined in claim 41, wherein the target reach percentage is a first target reach percentage, and further including means for comparing reach percentages to compare the second bucket reach percentage to a second target reach percentage, the second target reach percentage different than the first target reach percentage.

43.-44. (canceled)

45. An apparatus, comprising:
at least one memory;
instructions; and
processor circuitry to execute the instructions to:
obtain market data and a target reach percentage, the market data including test households and control households;
generate a first attribute bucket, the first attribute bucket including a first subset of the market data;
determine a first bucket reach percentage of the first subset of the market data;
in response to the first bucket reach percentage being less than the target reach percentage, determine a number of control households to remove from the first subset of the market data based on a size of the first subset of the market data and a difference between the first bucket reach percentage and the target reach percentage;
pseudo-randomly select a corresponding number of the control households to be removed from the first subset of the market data based on the determined number of control households to be removed;
remove the selected control households from the first subset of the market data to generate a first adjusted subset of the market data; and
aggregate the first adjusted subset of the market data with a second adjusted subset of the market data to form balanced market data for market analysis, the second adjusted subset associated with a second attribute bucket, the second attribute bucket including a second subset of the market data.

46. The apparatus as defined in claim 45, wherein the processor circuitry is to execute the instructions to determine an observed reach percentage of the market data.

47. The apparatus as defined in claim 46, wherein the processor circuitry is to execute the instructions to generate the first attribute bucket in response to the observed reach percentage being less than the target reach percentage.

48. The apparatus as defined in claim 45, wherein the processor circuitry is to execute the instructions to generate the second attribute bucket including the second subset of the market data based on a household attribute different than a household attribute associated with the first subset of the market data.

49. The apparatus as defined in claim 48, wherein the processor circuitry is to execute the instructions to determine a second bucket reach percentage of the second subset of the market data.

50. The apparatus as defined in claim 49, wherein the target reach percentage is a first target reach percentage, and the processor circuitry is to execute the instructions to compare the second bucket reach percentage to a second target reach percentage, the second target reach percentage different than the first target reach percentage.

51. The apparatus as defined in claim 1, wherein the number of control households is a first number of control households;
the attribute controller is to generate the second attribute bucket including the second subset of the market data;
the reach determiner is to determine a second bucket reach percentage of the second subset of the market data; and
the data controller is to:
in response to the second bucket reach percentage being less than the target reach percentage, determine a second number of control households to remove from the second subset of the market data based on a size of the second subset of the market data and a difference between the second bucket reach percentage and the target reach percentage;
pseudo-randomly select a corresponding number of control households to remove from the second subset of the market data based on the determined second number of control households to be removed; and
remove the selected control households from the second subset of the market data to generate the second adjusted subset of the market data.

52. The apparatus as defined in claim 51, wherein the control households in the balanced market data have proportionate attributes within a threshold of a proportionality of attributes of the test households.

53. The apparatus as defined in claim 1, wherein the attribute generator is to generate the first attribute bucket based on mutually exclusive, collectively exhaustive attributes of households within the first attribute bucket.
